(19) United States
(12) Patent Application Publication
(10) Pub. No.: US 2026/0349204 A1
(43) Pub. Date: Nov. 5, 2026

(54) ACTIVE PARTIALLY DESTRUCTIBLE LASER PROTECTION DEVICE, AND ASSEMBLY AND LASER SYSTEM WITH THE FORMER, AND METHOD FOR OPERATION THEREOF

(71) Applicant: TRUMPF Lasersystems for Semiconductor Manufacturing SE, Ditzingen (DE)

(72) Inventor: Stefan Piehler, Stuttgart (DE)

(21) Appl. No.: 19/710,418

(22) Filed: Jun. 17, 2026

Related U.S. Application Data
(63) Continuation of application No. PCT/EP2024/083785, filed on Nov. 27, 2024.

(30) Foreign Application Priority Data
Dec. 21, 2023 (DE) 10 2023 136 333.6

(51) Int. Cl. G02B 6/42; B23K 26/70; G01J 1/04; G01J 1/42; H01S 3/00

(52) U.S. Cl. CPC G02B 6/4296; B23K 26/706; G01J 1/0474; G01J 1/4257; G02B 6/42; G02B 6/4202; H01S 3/0014; H01S 3/0071; G02B 2006/4297

(57) ABSTRACT

A laser protection device includes a waveguide for guiding laser radiation in a direction of extension, and an absorber material covering a front side of the waveguide. The absorber material is configured to absorb the laser radiation incident on a side thereof facing away from the waveguide, thereby the absorber material is partially destroyed at a point of incidence of the laser radiation. The laser protection device further includes a scattering structure arranged on a rear side of the waveguide, and a detector arranged on the waveguide and distinct from the absorber material. The detector is covered in relation to potential directions of incidence of the laser radiation on the absorber material before the absorber material is partially destroyed. The laser protection device is configured to output a signal to cause a source of the laser radiation to be switched off when the laser radiation is detected by the detector.

### CROSS REFERENCE TO RELATED APPLICATIONS

This application is a continuation of International Application No. PCT/EP2024/083785 (WO 2025/131597 A1 ), filed on Nov. 27, 2024, and claims benefit to German Patent Application No. DE 10 2023 136 333.6, filed on Dec. 21, 2023. The aforementioned applications are hereby incorporated by reference herein.

### FIELD

Embodiments of the present invention relate to a laser protection device, i.e., a protection device for protection against unintentionally escaping laser radiation, as well as a laser optics assembly and laser system equipped therewith. The invention further relates to a method for operating such a laser system.

### BACKGROUND

Lasers can be used to great advantage in many different applications, for example for material processing or for generating UV radiation, for example for EUV lithography. In many cases, increasingly higher power or intensity of the laser radiation is required. This can lead to problems and even safety risks. For example, with increasing system power, thermal and mechanical stresses in a laser system can increase, which can negatively affect the positional stability of components and the robustness or reliability of the laser system. Furthermore, scattered light or reflections, or, for example, due to misalignment or destruction of beam-guiding components in the laser system, can damage surrounding components or people in the vicinity by uncontrolled or unintentional laser radiation escaping from the system.

One approach to addressing these challenges is known from DE 10 2006 053 579 A1, which describes a laser protection device with a passive laser protection wall that deposits radiation energy from a laser. A laser protection device is provided there, positioned in front of the laser radiation, which causes a change that can be detected when laser radiation impinges on it. A sensor is connected to a suitable laser via a threshold switch in order to switch off the laser via a received detector signal when a threshold value is exceeded or fallen below.

### SUMMARY

Embodiments of the present invention provide a laser protection device for protection against laser radiation. The laser protection device includes a flatly extending waveguide for guiding laser radiation entering therein in at least one main direction of extension, and an absorber material covering a front side of the waveguide. The absorber material is configured to absorb the laser radiation incident on a side thereof facing away from the waveguide. Thereby, the absorber material is partially destroyed at a respective point of incidence of the laser radiation. The laser protection device further includes a scattering structure arranged on a rear side of the waveguide for scattering at least a portion of the laser radiation entering the waveguide in a direction that enables the laser radiation to propagate in the at least one main direction of extension of the waveguide, and at least one detector arranged on the waveguide and distinct from the absorber material for detecting the laser radiation. The at least one detector is covered at least in relation to potential directions of incidence of the laser radiation on the absorber material at least before the absorber material is partially destroyed. The laser protection device is configured to automatically output a signal to cause a source of the laser radiation to be switched off when the laser radiation is detected by the at least one detector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser system with an integrated protection device against unintentionally escaping laser radiation according to some embodiments;

FIG. 2 shows a schematic sectional view illustrating the construction of the protection device according to some embodiments;

FIG. 3 shows a schematic sectional view further illustrating the construction of the protection device according to some embodiments; and

FIG. 4 shows a schematic sectional view illustrating a detector contact in the protection device according to some embodiments.

### DETAILED DESCRIPTION

Embodiments of the present invention can enable the safe operation of a high-performance laser system.

The laser protection device according to embodiments of the invention is designed to protect, for example, an environment or surrounding persons from uncontrolled laser radiation escaping or propagating in an unintentional manner. Since the laser protection device according to embodiments of the invention is not a simple passive barrier impermeable to laser radiation, it can also be referred to as an active laser protection device. The laser protection device has a flatly extending waveguide element for guiding or directing incoming laser radiation at least in one main direction or dimension of extension or main area or plane of extension of the waveguide element. The waveguide element can be in the form of a plate or foil, i.e., much larger in two directions or dimensions than in the third direction or dimension. The waveguide element can therefore be thin compared to its size, for example having a thickness in the range of less than 1 cm, in particular in the range of 1 mm or 100 μm, but extending over many centimeters or decimeters or meters in the two perpendicular directions or dimensions. The waveguide element is configured or designed to guide laser radiation at least substantially perpendicular to its thickness or parallel to or in its main direction or area of extension.

The laser radiation can be guided in the waveguide element, for example, by internal total reflection and/or scattering at inner front and rear sides. The waveguide element can therefore be at least essentially transparent to the laser radiation to be guided or ultimately detected. Depending on the application, i.e., depending on the wavelength of the laser radiation used, a material or material composition for the waveguide element can be selected accordingly. If multiple laser beams with different wavelengths are used, the waveguide element can only be transparent to the laser radiation that is ultimately intended to be detected. In such a case, it is advantageous if the waveguide element is not transparent to the laser radiation of the other laser beams. This can be achieved, for example, using appropriate filters.

The laser protection device also comprises an absorber material or absorber element that covers a front side of the waveguide element, i.e., is arranged or attached to the front side of the waveguide element and extends over a surface area, just like the waveguide element. The absorber material can therefore completely or almost completely cover one of the two sides of the waveguide element that are spanned by its two main directions or dimensions of extension. The absorber material or absorber element is designed to absorb laser radiation incident on its side facing away from the waveguide element, i.e., on the front of the absorber material, and thereby be destroyed at the respective point of incidence of the laser radiation, i.e., in particular only in a corresponding punctiform manner or in sections. The absorber material can be thermally destroyed by the energy deposited in it by the laser radiation, for example by evaporating, melting, charring, and/or shrinking, causing it to tear, curl up in certain areas, or the like. This can be achieved or ensured by selecting a suitable material and/or thickness of the absorber material perpendicular to its main plane or surface, i.e., perpendicular to the front side, for the specific application, i.e., the wavelengths of laser radiation used. The absorber material can be a coating, for example a layer of paint or varnish or the like, on the waveguide element. Similarly, the absorber material can be a separate component located on the front side of the waveguide element. The absorber material can then be held to the waveguide element, for example, by an adhesive, electrostatically, or due to the surrounding air pressure.

The laser protection device according to embodiments of the invention also has a scattering structure or scattering layer arranged on the rear side of the waveguide element opposite the front side for scattering at least a portion of the laser radiation entering the waveguide element in a direction that enables the laser radiation to propagate in at least one main direction or dimension of extension of the waveguide element. The scattering structure thus serves, for example in the case of a flatly extending waveguide element, to scatter at least a portion of the laser radiation entering it parallel to its front and rear sides and/or at an angle to them, at which the laser radiation fulfills a condition for total reflection at the inner surfaces or the front and rear sides of the waveguide element. The scattering structure can be designed or configured in particular to enable this to occur at least essentially independently of the direction of incidence or impact of the laser radiation on the absorber material or the scattering structure. The scattering structure can therefore be configured or designed to scatter incident laser radiation in a multitude of different directions or angles. The scattering structure can, for example, be or comprise a predefined regular structure, or a random or stochastic roughening, or the like. The scattering structure can be formed in the material of the waveguide element itself. Similarly, the scattering structure can be an independent component that is arranged or attached to the rear side of the waveguide element, i.e., opposite the absorber material, for example analogous to the absorber material.

The laser protection device according to embodiments of the invention also has at least one detector arranged on the waveguide element and distinct or separate from the absorber material for detecting the laser radiation guided in the waveguide element or emerging from it into or onto the detector. At least one detector is covered or shielded against laser radiation or other light or ambient brightness at least in relation to potential directions of incidence of the laser radiation on the front side of the absorber material, at least before the partial destruction of the absorber material by the laser radiation. The detector can, for example, be covered or shielded by the absorber material, which is initially opaque to the laser radiation. As long as the absorber material of the laser protection device is not destroyed by incident laser radiation during its intended use, for example in a laser system or along an intended beam path or beam course of a laser beam, the detector would not detect any laser radiation, in particular not even scattered radiation that does hit the laser protection device but is not intense or powerful enough to destroy the absorber material in a punctiform manner. If, however, laser radiation enters the waveguide element, this laser radiation can be detected by means of the at least one detector even if it is spatially separated from a point of incidence or an entry point of the laser radiation, since at least a portion of the laser radiation is guided within the waveguide element up to the detector. This means that a correspondingly large area can be monitored for incident laser radiation using a significantly smaller detector surface. This can enable a comparatively simple and cost-effective construction of the laser protection device, since detectors can be relatively expensive and require significant effort, for example, in terms of their electrical supply, signal tapping, and signal evaluation.

According to embodiments of the invention, the laser protection device is configured to automatically output a corresponding electrical electronic signal upon detection of laser radiation by means of the at least one detector, in order to cause or trigger the switching off of a source of laser radiation. Such a signal can be generated and output, for example, by the detector itself or by a signal processing unit coupled to it. Such a signal processing unit can, for example, detect and evaluate a sensor or detector signal from at least one detector and, if necessary, generate and output a control signal or switch-off signal to switch off the laser radiation source or to cause or trigger its switching off.

The laser protection device proposed here can essentially have a multi-layered structure. This provides a simple, relatively easy-to-integrate, and possibly also relatively easy-to-retrofit option for ensuring laser protection in systems, machines, beam guidance optics and corresponding working areas. Since the various layers of the laser protection device according to embodiments of the invention can be relatively thin, application or installation is possible even in confined installation situations where there is little space available for the laser protection device. An advantage of the laser protection device according to embodiments of the invention is that at least one detector can be shielded at least substantially completely from ambient light, low-intensity scattered radiation and the like, so that detection only occurs in the event of actual partial destruction of the front-side absorber material by correspondingly intense laser radiation impinging on it. This means that the laser protection device according to embodiments of the invention can be used as a particularly robust and reliable fault sensor for detecting and intercepting serious safety incidents in which there are significant deviations from an intended beam path or beam guidance, in order to prevent or limit an uncontrolled emission of laser radiation into the environment. The laser protection device according to embodiments of the invention can employ an optical detection principle, i.e., direct detection of the laser radiation by means of at least one detector. This can be particularly robust against electromagnetic, thermal and electrical influences, for example, and enable a particularly fast and precise response, for example compared to thermal sensors. The waveguide element and the absorber material or the scattering structure can be manufactured as large-scale mass-produced components, for example in the form of a foil web, and are therefore particularly cost-effective and practical to produce.

The laser protection device according to embodiments of the invention can be used as a fixed, i.e., permanently arranged and remaining at a respective place of use, protection and detector and can therefore fulfill the described detection and protection task particularly easily and permanently without further effort.

The laser protection device according to embodiments of the invention can be adapted to various requirements or applications due to its design. Due to the fact that, for example, the absorber material, i.e., a corresponding absorber layer, must first be locally destroyed in order to then enable detection of the corresponding laser radiation, the response behavior or response level of the laser protection device can be adjusted via the selected thickness and/or material of the absorber material. In particular, this allows relatively minor errors to be distinguished from more serious errors or problems and addressed accordingly. In the event of a minor fault, for example, a slight or weak misalignment can occur, resulting in only a very small proportion of the laser radiation used in the respective application hitting the laser protection device. This portion may, for example, not have enough intensity or power to destroy the absorber material. In the case of such a minor fault, there is typically no significant risk of laser radiation escaping or, if it does escape, causing damage or danger. In the case of a more serious fault, however, there can be such a severe misalignment or damage that at least a large part of the laser radiation hits the laser protection device. If, in such a case, the majority of the laser radiation or the entire laser beam were to escape into the environment, this could lead to significant damage or danger. In such a case, however, due to the corresponding intensity or power of the laser radiation, the absorber material can be destroyed at least locally, and the laser radiation can be detected by means of at least one detector of the laser protection device, and the laser radiation source can then be automatically switched off. This can not only prevent or minimize damage or corresponding danger, but also indicate in itself that a correspondingly serious fault has occurred and therefore a corresponding repair or readjustment is necessary.

It is also advantageous that, due to the absorbing design or construction of the absorber material, reflection of laser radiation incident on the absorber material can be limited or minimized. This can prevent damage to the laser system, beam guidance device, or similar components from being caused by reflections. In this case, the absorber material used is therefore a material that does not reflect the laser radiation, or reflects it insignificantly, or only as weakly as possible.

In one possible embodiment of the present invention, the waveguide element and/or the absorber material is/are designed as a foil. For example, the waveguide element here can be a PMMA foil (polymethyl methacrylate) or a PC foil (polycarbonate). The absorber material or absorber element can be, for example, an aluminum foil, in particular one that is oxidized on the surface, or an anodized layer, or the like. The waveguide element and/or the absorber material or element can, for example, have a thickness in the range of 100 μm. The proposed design as a foil or foils allows for the use of cost-effective and established production processes and enables large-scale manufacturing. This also allows for easy cutting to the required sizes or shapes for each application. Furthermore, the foil-like and therefore flexible design of the laser protection device, or at least the layer structure consisting of the absorber material and the waveguide element or the scattering structure, makes it possible to cover large areas of potentially endangered areas as well as complex shapes in a particularly simple, cost-effective and inexpensive way. If the scattering structure is not implemented via an inherent structuring of the waveguide element itself, the scattering structure or scattering layer can also be designed as a foil.

In another possible embodiment of the present invention, the waveguide element is designed as a plate component. Such a plate component can be thicker than a foil, for example having a thickness in the range of 1 mm or several millimeters. In particular, the waveguide element can be inherently stable, i.e., it can independently maintain its flat, plate-like shape or be flexurally rigid. For example, the waveguide element can be designed as a glass plate, in particular as a float glass plate, quartz glass plate or sapphire glass plate. The waveguide element can be coated with the absorber material as described, or covered with a foil serving as absorber material. The design proposed here can enable the laser protection device to be used for particularly high laser power levels. This allows laser radiation with higher power and/or higher intensity to be guided non-destructively in the waveguide element, for example, if the waveguide element were designed as a plastic foil.

In another possible embodiment of the present invention, the scattering structure is provided as a structuring of the rear side of the waveguide element itself, which faces away from or opposite to the absorber material. In other words, the scattering structure here is not an independent component or material. For example, the rear side of the waveguide element can be structured or roughened by shot peening or sandblasting, or by mechanical or laser-based microstructuring, or by other processing methods, and thereby exhibit the described functionality for scattering laser radiation incident on the inside. The embodiment of the present invention proposed here thus allows for the elimination of a corresponding additional component for the scattering structure. This allows the laser protection device to be built in a particularly simple and compact way.

In another possible embodiment of the present invention, the scattering structure is designed as a separate component applied to the rear side of the waveguide element, i.e., attached or arranged on the rear side, extending over the same area as the waveguide element, or as a coating of the rear side of the waveguide element with an additional light-scattering material. This allows the scattering properties of the scattering structure or scattering layer to be adjusted or predetermined in a particularly flexible and precise manner, in particular independent of the thickness or material of the waveguide element. This can be useful, for example, if the waveguide element is so thin that directly machining or roughening its rear side to create the scattering structure would be too costly or would pose a risk of destruction or unintentional perforation of the waveguide element during manufacturing. The proposed embodiment of the present invention thus allows the laser protection device to be manufactured in a way that meets specific requirements, is particularly reliable and easy to manufacture.

In another possible embodiment of the present invention, the laser protection device has multiple or a plurality of detectors for detecting the laser radiation which can be guided in the waveguide element or which can emerge from it into or onto the detector. These multiple detectors are spatially spaced apart and distributed across the rear side of the waveguide element. The detectors can be arranged in a matrix-like manner, i.e., in a regular grid or checkerboard pattern, or in regular rows and columns, or the like. The proposed use of multiple detectors can enable particularly fast and reliable detection of the laser radiation without, for example, having to equip or cover the entire rear side or surface of the waveguide element with detector elements. The laser radiation cannot be guided within the waveguide element in a completely lossless manner, for example, and can therefore only be detected up to a limited distance from the point of incidence or impact of the laser radiation on the absorber material or into the waveguide element. The distributed arrangement of the multiple detectors at appropriate intervals proposed here allows for reliable detection of the laser radiation even with a large-scale design or application of the laser protection device, with limited effort.

In a possible further embodiment of the present invention, common connecting elements or common contacting elements or common bridges are arranged on two end faces or edges of the waveguide element, to which an electrical contact of all detectors distributed over the rear side of the waveguide element is electrically connected. Therefore, one side or pole of the detectors can be connected to one common connecting element and the other side or pole of the detectors can be connected to the other common connecting element. The common connecting elements can, in turn, offer a simple and bundled connection or contacting option for tapping the signals from the detectors. For example, a data or signal processing unit can then be connected to the common connecting elements and thus does not need to be individually connected to each individual detector separately. This can enable a simplified construction and handling of the laser protection device. The detectors can be connected to the common connecting elements, for example, via flexible conductor tracks or conductive foils. This allows the flexibility of the layer structure of the laser protection device to be maintained, for example in the design of at least the waveguide element as a foil, as described elsewhere. Corresponding connecting lines from the detectors to the common connecting elements can, for example, be arranged on the rear side of the scattering structure, i.e., on a rear side of the scattering structure or scattering layer facing away from the waveguide element. There, for example, they can be glued on or embedded or integrated into another layer, such as a shield described elsewhere or the like. Some or all of the detectors can be connected via individual lines or to the common connecting elements. Similarly, multiple detectors can be connected via the same line or connected to one of the common connecting elements. For example, with a regular arrangement of the detectors, all detectors in a column can be connected to one line and all detectors in a row can be connected to a different line. In this way, a relatively simple contacting or wiring of the detectors can be achieved, and at the same time it can be determined which of the detectors detects the laser radiation or, for example, the greatest intensity of the laser radiation. This makes it possible to determine in which of the lines for the different columns of detectors and in which of the lines for the different rows of detectors a detector signal, or the largest detector signal, is present or is being detected. The combination of the corresponding row and column then specifies the corresponding detector. Likewise, other contact configurations or wiring of the detectors may be possible. For example, all or a plurality of the detectors can be connected in series or in parallel, or in a combination, i.e., in several groups of detectors connected in series or in parallel.

In a further possible embodiment of the present invention, the detector or at least one detector for detecting the laser radiation guided in the waveguide element or emerging from it into or onto the detector is arranged on an end face of the waveguide element. Such an arrangement allows the laser protection device to be designed to be particularly thin and simple, at least over most of its area. On the other hand, laser radiation can be detected by means of an end-face arrangement of at least one detector, which propagates within the waveguide element exactly parallel to its front and rear sides and thus ultimately impinges on the corresponding end face or the detector located there. The end face can therefore be a narrow side of the waveguide element that is at least essentially perpendicular to the front and rear side faces. With the detector positioned there, it is located at the edge of the waveguide element and can therefore be contacted particularly easily. This can, for example, save the corresponding manufacturing effort for arranging and wiring a detector on the rear side of the waveguide element. However, one or more detectors can also be arranged on the end face or multiple end faces and additionally on the rear side of the waveguide element. This enables particularly reliable detection of laser radiation that has entered the waveguide element.

In a further possible embodiment of the present invention, a flatly extending shield, like the waveguide element, is arranged on the rear side of the scattering structure facing away from the waveguide element or the absorber material. This shield is opaque to laser radiation and stable against or insensitive to incident laser radiation- or at least more stable or insensitive compared to the absorber material. Such a shield can prevent laser radiation from escaping from the waveguide element to its rear side and then into the environment. This means that the safety and protective effect of the laser protection device can be further improved. Secondly, the shield can prevent light or radiation from the environment from entering the waveguide element through its rear side and reaching the detector. This helps avoid the risk of false detections. The shield can, for example, be designed to withstand the laser radiation for at least a predetermined period of time that is greater than the time that elapses from the initial entry of the laser radiation into the waveguide element until the resulting switching off of the laser radiation source. This can enable a corresponding improvement in the safety and reliability of the laser protection device, while still preserving its flexibility if necessary. For example, a metal foil or an arrangement of multiple layers of metal foil can be used as a shield. In particular, in the case that the waveguide element is designed in the form of a plate, the shield can also be designed in the form of a plate and thus offer a correspondingly increased robustness. If at least one detector is arranged on the rear side of the waveguide element, it can, for example, be embedded in the shield or corresponding recesses of the shield, or be surrounded by the shield. Similarly, the shield can also cover the rear side of the detector itself, thus providing additional protection against unwanted detection of radiation or light from the environment and/or holding or fixing at least one detector.

In another possible embodiment of the present invention, the laser protection device is designed to output the signal only if, or when, the detected laser radiation meets a predetermined criterion. One such criterion can be that the intensity of the laser radiation and/or the increase in the intensity of the laser radiation within a predetermined time period, i.e., the gradient of a corresponding intensity signal, corresponds to at least one predetermined threshold value. This allows the system to be set as needed, for example, so that the laser radiation source is only switched off in the case of potentially critical problems and not in the case of scattered radiation reaching the detector that is not critical from a safety or functional perspective. In particular, by detecting an increase, i.e., a signal edge, as a criterion, it is also possible, for example, to take into account a residual or background intensity arriving at the detector during safe operation. This means, for example, that the laser protection device does not need to be replaced or repaired after a previous punctiform destruction of the absorber material, even if radiation or light still enters the waveguide element during safe operation due to this damage, for example after a correction of a misalignment responsible for it, or the like.

Embodiments of present invention also relate to a laser optics assembly for guiding a laser beam along a predetermined beam path or beam course. The laser optics assembly has a housing, on the sides of which the laser protection device or a laser protection device according to embodiments of the invention is arranged such that its absorber material faces the intended beam path or beam course. The laser protection device can be arranged, in particular, on the inside of the housing. Depending on the application or situation, it may also be possible to arrange the laser protection device on the outside of the housing or to integrate the laser protection device into the housing walls. A corresponding laser optics assembly can be, for example, a beam guidance tube or channel, a beam guidance optical unit or device, a beam shaping optical unit or device, or a deflecting or scanner mirror, modulator, phase shifter, or the like, each arranged in a housing. With such laser optics assemblies, at least part of a laser system can be built modularly, wherein the integrated laser protection devices automatically result in a correspondingly high level of protection or safety for the laser system, for example without the need to additionally enclose the entire system in a housing or a comprehensive laser protection device. This allows for a simple construction of such a laser system and good external accessibility to its components.

Embodiments of present invention also relate to a laser system comprising at least one laser radiation source. In the laser system, the laser protection device or a laser optics assembly according to embodiments of the invention is arranged along a defined beam path of a laser beam. The laser system according to embodiments of the invention is designed to automatically switch off the laser radiation source in response to a signal from at least one laser protection device. For example, the laser system can comprise a corresponding signal processing and switch-off device, which can be connected to the laser protection device on the one hand and to the laser radiation source on the other. Likewise, at least one laser protection device can be directly connected to the laser radiation source, which can then be configured to automatically stop the generation or output of laser radiation in response to a signal sent by the laser protection device. The laser system according to embodiments of the invention can in particular be or correspond to the laser system mentioned in connection with the laser protection device and/or the laser optics assembly according to embodiments of the invention.

Embodiments of the present invention also relate to a method for operating the laser system according to embodiments of the invention. In this system-after commissioning the laser system including the at least one laser protection device-a corresponding signal is generated by the at least one detector of the at least one laser protection device in response to the detection of laser radiation, and the laser radiation source is automatically switched off upon detection of this signal or by this signal.

Switching off the laser radiation source in the present sense can mean that the generation of laser radiation by means of the laser radiation source is terminated or that the laser radiation that continues to be generated is no longer emitted from the laser radiation source. The latter can be achieved, for example, by deflecting the laser radiation within the laser radiation source into a beam trap or an absorber or dump output of the laser beam source. Further measures, procedures or processes mentioned in connection with the laser protection device and/or laser optics assembly and/or laser system according to embodiments of the invention may constitute further, optional method steps of the method according to embodiments of the invention.

Identical or functionally identical elements are provided with the same reference signs in the figures. For the sake of clarity, in the figures, only a representative selection of identical or similar elements that occur multiple times may be explicitly marked.

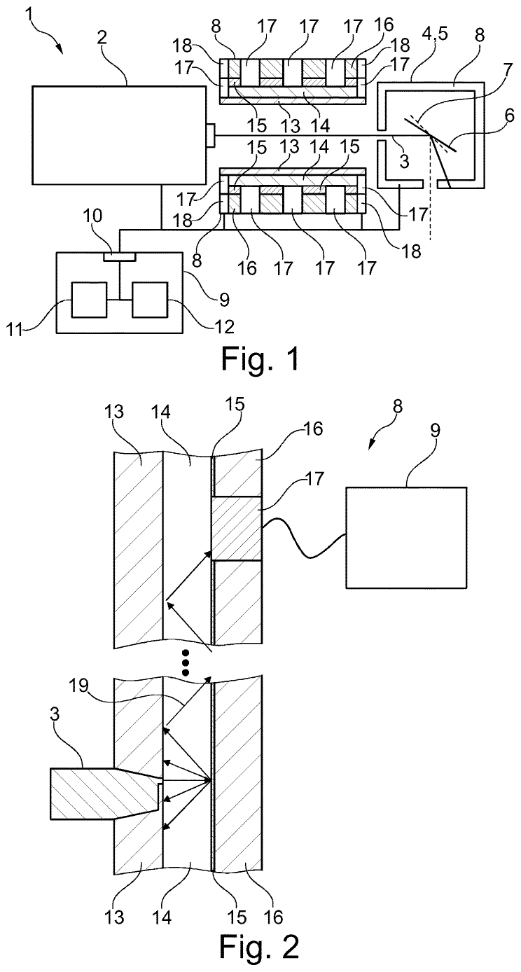

FIG. 1 shows a partial schematic representation of a laser system 1 having a laser radiation source 2. This laser radiation source 2 can output a laser beam 3. For example, the laser system 1 here also comprises an optics assembly 4. This optics assembly 4 comprises, by way of example only, a housing 5 with a deflecting mirror 6 arranged therein for deflecting the laser beam 3. In a correctly adjusted target position 7 of the deflecting mirror 6, indicated here by dashed lines, the laser beam 3 would exit through a designated outlet of the housing 5, which is also indicated here by dashed lines.

However, in the present case, a misalignment may have occurred, so that the deflecting mirror 6 is no longer in its intended position 7. This causes the laser beam 3 to be deflected in an unintended manner, so that it would, for example, impinge on an inside of the housing 5. The laser beam 3 could then potentially damage or even pierce the housing 5 and escape into the environment, or reflections of the laser beam 3 could occur inside the housing 5, which could cause laser radiation to escape into the environment through an inlet or at an unintended angle through the outlet of the housing 5.

Similarly, for example, the laser radiation source 2 could be misaligned, so that the laser beam 3 would not even enter the optics assembly 4.

To avoid or limit associated hazards or safety risks, the laser system 1 comprises a plurality of laser protection devices 8. These are arranged here as an example along a designated beam path or beam course from the laser radiation source 2 to the optics assembly 4 and on the inside of the housing 5. The laser protection devices 8 are coupled to a data or signal processing unit 9 of the laser system 1. The signal processing unit 9 has, for example, an interface 10 and is designed to process signals from the laser protection devices 8. For this purpose, the signal processing unit 9 comprises, for example, a corresponding circuit or, as schematically indicated here, a processor 11, i.e., a microchip or microprocessor or microcontroller or the like, and a computer-readable data storage device 12 coupled to it. The signal processing unit 9 is also designed to switch off the laser radiation source 2 or the output of the laser beam 3 by means of the laser radiation source 2, if necessary, in response to a signal sent by at least one of the laser protection devices 8. For this purpose, the signal processing unit 9 is also connected to the laser radiation source 2. Likewise, the signal processing unit 9 could, for example, be fully or partially integrated into the laser protection devices 8 and/or the laser radiation source 2.

The laser protection devices 8 here comprise, on their side facing the intended beam path or beam course of the laser beam 3, a layer consisting of an absorber material 13. This absorber material 13 can absorb the laser beam 3 impinging on it and thereby be destroyed in a punctiform manner, for example by evaporation or melting. On the reverse side of each is a waveguide element 14 in which a portion of the laser beam 3 entering after punctiform destruction of the absorber material 13 can be guided or transported as laser radiation 19 (see FIG. 2) perpendicular to the thickness direction of the absorber material 13 and the waveguide element 14. A scattering layer or scattering structure 15 is arranged on the rear side of the waveguide element 14 for scattering the laser radiation 19. This scattering structure 15 is in turn covered on the rear side by an opaque shield 16.

The laser protection devices 8 also each comprise a plurality of detectors 17 for detecting the laser radiation 19. By way of example, these detectors can be photodiodes or the like. The detectors 17 can, for example, be connected to connection elements 18, via which the respective laser protection device 8 can be connected to the signal processing unit 9.

To further illustrate the construction and function of the laser protection devices 8, FIG. 2 shows a partial schematic representation of a part of a laser protection device 8 and indicates the signal processing unit 9. The laser protection device 8 comprises a layered structure consisting of the absorber material 13, the waveguide element 14, the scattering structure 15 and the shield 16. By way of example, the waveguide element 14 can be designed here as a waveguide and scattering foil, on which the absorber material 13 is attached as an absorber foil on the front side. To form the scattering structure 15, the waveguide element 14 can be structured on its rear side in such a way that laser radiation 19 entering the waveguide element 14 and striking its rear side from the inside, i.e., an inside or front side of the scattering structure 15, is scattered in different directions, as schematically indicated here. For this purpose, the rear side of the waveguide element 14 can be structured, for example by means of shot peening or sandblasting, or provided with a microstructure, such as microcones or micropyramids or the like. Likewise, the waveguide element 14 can be covered with a foil or a coating which forms the scattering structure 15. Instead of a foil, for example made of a plastic material such as PMMA or the like, the waveguide element 14 can also be formed as a plate-shaped component, for example made of float glass or quartz glass or sapphire or the like. The rear-mounted shield 16 can be opaque and prevent ambient light from entering the waveguide element 14.

In the section shown here, one of the detectors 17 is also indicated. This is arranged directly on the waveguide element 14. In particular, no scattering structure 15 may be present on a front side of the detector 17 or of all detectors 17 facing the waveguide element 14. In other words, the detectors 17 can be arranged in corresponding recesses or holes of the scattering structure 15, or the scattering structure 15 can only be arranged or formed only in the regions of the rear side of the waveguide element 14 located between the detectors 17 or surrounding the detectors 17. The detectors 17 for detecting the laser radiation 19 can therefore be arranged or attached directly to the rear side of the waveguide element 14, for example by gluing or adhesively bonding them. This allows laser radiation 19 impinging on the inner rear side of the waveguide element 14 in the region of a detector 17 to be detected particularly effectively in or by the detector 17.

As can also be seen in FIG. 1, in the normal operation of the laser system 1, which is fault-free or adjusted as intended, the laser beam 3 does not impinge on any of the laser protection devices 8. Any scattered light that may nevertheless impinge on the laser protection devices 8 or their absorber material 13, which may have a much lower intensity or power compared to the laser beam 3, can be completely or almost completely absorbed in the absorber material 13 without destroying or penetrating it. At least virtually no light or laser radiation 19 is then guided in the waveguide element 14. If, in the event of a fault, for example in the case of a misalignment of the deflecting mirror 6 or the laser radiation source 2, or in the event of a failure of a corresponding control or the like, the laser beam 3 impinges on a laser protection device 8 or its absorber material 13 as indicated here, the absorber material 13 can be destroyed at least in a punctiform manner by the incident laser beam 3. In this case, at a certain point in time, the laser beam 3 enters the waveguide element 14, which until then had not guided light or radiation, or had guided only an insignificant amount of it. The laser beam 3 then passes through the waveguide element 14 in the form of the laser radiation 19 indicated here and impinges on the scattering structure 15 or its front side. There, the laser radiation 19 is at least partially scattered in such a way that a certain proportion of the laser radiation 19 fulfills the angular condition for internal total reflection within the waveguide element 14. Thus, the corresponding portion of the scattered laser radiation 19 travels within the waveguide element 14 in at least one of its main directions of extension or in the transverse direction. This means that after a certain time the scattered laser radiation 19 reaches one of the detectors 17, where it is detected. The corresponding detector 17 can output a corresponding detector signal to the signal processing unit 9. There, the detector signals of the detector 17, or of all of the detectors 17, can be processed or evaluated. If it is ascertained that the detected laser radiation 19 reaches or exceeds a predetermined threshold value, or if a corresponding signal edge, i.e., an increasing detected laser radiation intensity, is ascertained, the signal processing unit 9 can send a switch-off signal, i.e., a signal to switch off the laser radiation source 2 or to switch off the output of the laser beam 3 to the laser radiation source 2, for example via the interface 10.

In particular, the laser protection device 8 and the signal processing unit 9 can be designed to cause this switching off of the laser radiation source 2 or the laser beam 3 so quickly that, up until the time the laser beam 3 is switched off at its point of incidence on the absorber material 13, it has not yet destroyed the absorber material over the entire cross-section or diameter of the laser beam 3, or the laser radiation 19 has not yet escaped via the rear side or an end face of the waveguide element 14, or the shield 16 has not yet been penetrated.

The signal processing unit 9 can therefore be considered here as a combined evaluation unit that evaluates a detector signal generated by one of the detectors 17 indicating the detected laser radiation 19, and, for example, generates or outputs a corresponding fault signal or the switch-off signal from a certain threshold value, and a safety device that, if necessary, switches off the laser radiation source 2 or the laser beam 3 when the corresponding fault signal has been generated, or generates the switch-off signal and sends it to the laser radiation source 2.

In other words, a laser protection device 8 is proposed here which, for example in the event of a fault, i.e., if the laser beam 3 unexpectedly deviates from its intended beam path or beam course and thus a potential hazard exists—possibly in combination with the signal processing unit 9—generates a corresponding fault or switch-off signal which can be read out, for example by a corresponding safety device or safety circuit, and causes the laser radiation source 2 or the laser beam 3 to be switched off.

The scattering structure 15 also allows any perpendicularly incident laser radiation 19 to be coupled at least partially into the waveguide element 14 so that it can propagate at least as far as the nearest detector 17. The detectors 17 can be permanently integrated into the respective laser protection device 8 at a corresponding distance, for example in a regular pattern.

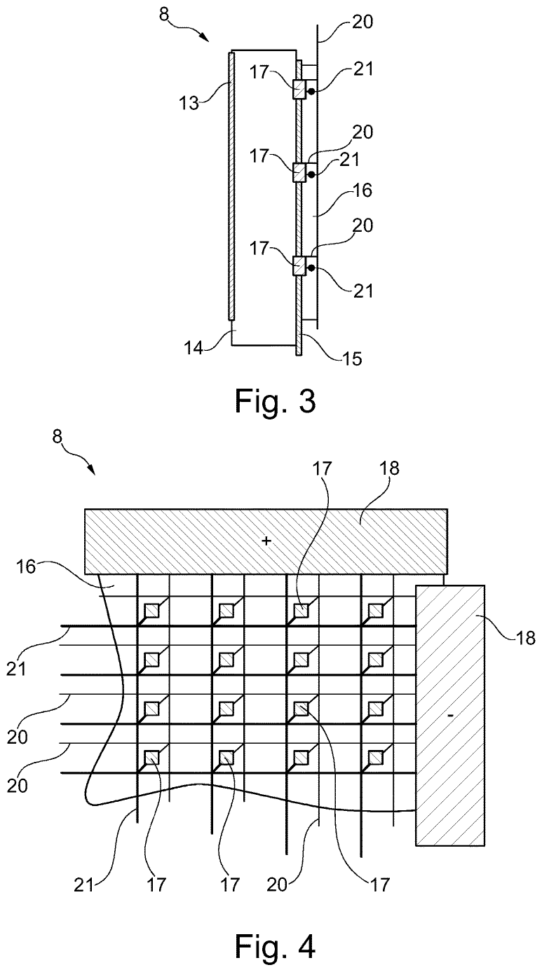

For the purposes of further illustration, FIG. 3 and FIG. 4 show partial schematic representations of one of the laser protection devices 8 from different viewing directions. The individual detectors 17 can be electrically connected or contacted by means of appropriate lines or flexible conductive foils, for example in parallel and/or in series. One example shown here is a matrix-like arrangement and contacting of the detectors 17. For this purpose, the detectors 17 are provided via first connecting lines 20 running at least substantially in a first main extension direction of the waveguide element 14 and, for example, second connecting lines 21 running perpendicular thereto in the second main extension direction of the waveguide element 14. In FIG. 3, the second connecting lines 21 can run at least substantially perpendicular to the drawing plane.

In FIG. 4 the matrix-like arrangement and contacting of the detectors 17 can be seen even more clearly. The first connecting lines 20 and the second connecting lines 21 can connect the detectors 17 to the connecting elements 18 arranged laterally or at the edge of the waveguide element 14. There, the connecting lines 20, 21 can, for example, pierce or protrude through the shield 16 up to the respective connecting element 18. The arrangement shown here can allow a flexible design and adaptation of the laser protection devices 8 to spatial conditions or different sizes of the various laser protection devices 8. For example, their layered structure can first be manufactured as a continuous web. This can then be cut to size as required and the cut pieces can then be provided with the connecting elements 18.

Overall, the examples described show how an active laser protection device can be set up and used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser system
2 Laser radiation source
3 Laser beam
4 Optics assembly
5 Housing
6 Deflecting mirror
7 Target position
8 Laser protection device
9 Signal processing unit
10 Interface
11 Processor
12 Data storage device
13 Absorber material
14 Waveguide element
15 Scattering structure
16 Shield
17 Detector
18 Connecting element
19 Laser radiation
20 First connecting lines
21 Second connecting lines

1. A laser protection device for protection against laser radiation, the laser protection device comprising
a flatly extending waveguide for guiding laser radiation entering therein in at least one main direction of extension,
an absorber material covering a front side of the waveguide, wherein the absorber material is configured to absorb the laser radiation incident on a side thereof facing away from the waveguide, thereby the absorber material is partially destroyed at a respective point of incidence of the laser radiation,
a scattering structure arranged on a rear side of the waveguide for scattering at least a portion of the laser radiation entering the waveguide in a direction that enables the laser radiation to propagate in the at least one main direction of extension of the waveguide, and
at least one detector arranged on the waveguide and distinct from the absorber material for detecting the laser radiation, wherein the at least one detector is covered at least in relation to potential directions of incidence of the laser radiation on the absorber material at least before the absorber material is partially destroyed,
wherein the laser protection device is configured to automatically output a signal to cause a source of the laser radiation to be switched off when the laser radiation is detected by the at least one detector.

2. The laser protection device according to claim 1, wherein the waveguide and/or the absorber material is/are configured as a foil.

3. The laser protection device according to claim 1, wherein the waveguide is configured as a plate.

4. The laser protection device according to claim 1, wherein the scattering structure is configured as a structuring of the rear side of the waveguide.

5. The laser protection device according to claim 1, wherein the scattering structure is configured as a flatly extending component applied to the rear side of the waveguide or as a coating of the rear side of the waveguide.

6. The laser protection device according to claim 1, wherein the laser protection device comprises a plurality of detectors for detecting the laser radiation, wherein the plurality of detectors is arranged in a matrix-like manner, spatially distributed over the rear side of the waveguide.

7. The laser protection device according to claim 6, further comprising:
a common connecting element arranged on two edges of the waveguide, wherein an electrical contact of the plurality of detectors distributed over the rear side of the waveguide is electrically connected to the common connecting element.

8. The laser protection device according to claim 1, wherein the at least one detector for detecting the laser radiation is arranged on an end face of the waveguide.

9. The laser protection device according to claim 1, further comprising:
a flatly extending shield, wherein the shield is opaque to the laser radiation and stable against the laser radiation, the shield being arranged on a rear side of the scattering structure facing away from the waveguide.

10. The laser protection device according to claim 1, wherein the laser protection device is configured to output the signal only when the detected laser radiation meets a predetermined criterion.

11. A laser optics assembly for guiding a laser beam along a beam path, the laser optics assembly comprising a housing, and a laser protection device according to claim 1 arranged on sides of the housing such that the absorber material faces the beam path.

12. A laser system comprising a laser radiation source, and a laser protection device according to claim 1 arranged along a beam path, wherein the laser system is configured to automatically switch off the laser radiation source based on the signal output by the laser protection device.

13. A method for operating a laser system according to claim 12, wherein, when the laser radiation is detected by the at least one detector of the laser protection device, the signal is generated by the laser protection device, and the laser radiation source is automatically switched off based on the signal output by the laser protection device.
